(19) United States
(12) Patent Application Publication
(10) Pub. No.: US 2026/0145014 A1
(43) Pub. Date: May 28, 2026

(54) PILOT VALVE FOR DIAPHRAGM VALVE SYSTEMS AND METHODS

(71) Applicant: Tyco Fire Products LP, Cranston, RI (US)

(72) Inventors: Joshua Motha, Tiverton, RI (US); Normand James Roy, Coventry, RI (US)

(73) Assignee: Tyco Fire Products LP, Cranston, RI (US)

(21) Appl. No.: 19/123,295

(22) PCT Filed: Jan. 22, 2024
(86) PCT No.: PCT/IB2024/050603

§ 371 Date: Apr. 22, 2025

Related U.S. Application Data
(60) Provisional application No. 63/481,044, filed on Jan. 23, 2023.

(51) Int. Cl. A62C 35/68; A62C 35/62; A62C 37/46

(52) U.S. Cl. CPC A62C 35/68; A62C 35/62; A62C 37/46

(57) ABSTRACT

A pilot valve can include an inlet chamber, a diaphragm chamber coupled with the inlet chamber, a drain chamber coupled with the diaphragm chamber, a diaphragm, a pilot channel coupled with the inlet chamber, and an actuator in the pilot channel. The diaphragm can be movable between a closed position to prevent fluid flow between the inlet chamber and the drain chamber and an open position to allow fluid flow between the inlet chamber and the drain chamber. The actuator can selectively allow fluid flow out of the pilot channel through a port coupled with the pilot channel to movement of the diaphragm.

### CROSS-REFERENCE TO RELATED APPLICATIONS

The present application claims the benefit of and priority to U.S. Provisional Application No. 63/481044, filed Jan. 23, 2023, the disclosure of which is incorporated herein by reference in its entirety.

### BACKGROUND

Fire protection systems can include valves that are used to selectively allow fluid to flow from a fluid supply to sprinklers. For example, some fire protection systems include diaphragm valves in which a flexible diaphragm, in a closed state of the valve, prevents fluid flow between an inlet and outlet of the valve, and can be triggered to move to an open state to allow flow between the inlet and the outlet.

### SUMMARY

At least one aspect relates to a fire protection system. The fire protection system can include a flow control valve, one or more sprinklers, and a pilot valve. The flow control valve can include an inlet, an outlet, a first diaphragm chamber between the inlet and the outlet, and a first diaphragm movable between a closed state to prevent fluid flow between the inlet and the outlet and an open state to allow fluid flow between the inlet and the outlet. The one or more sprinklers can be coupled with the outlet. The pilot valve can include an inlet chamber coupled with a diaphragm port of the first diaphragm chamber, a drain port, a second diaphragm in a second diaphragm chamber between the inlet chamber and the drain port, and an actuator in a pilot channel between the inlet chamber and an air port and between the inlet chamber and the drain port, the actuator to prevent fluid flow between the inlet chamber and the drain port through the pilot channel responsive to pressurization of one or more pipes between the outlet and the one or more sprinklers, the air port coupled with the one or more pipes, the actuator to allow fluid flow between the inlet chamber and the drain port and between the second diaphragm chamber and the drain port responsive to pressure in the one or more pipes being less than a threshold to allow operation of the flow control valve.

At least one aspect relates to a pilot valve. The pilot valve can include an inlet chamber, a diaphragm chamber coupled with the inlet chamber, a drain chamber coupled with the diaphragm chamber, a diaphragm, a pilot channel coupled with the inlet chamber, and an actuator in the pilot channel. The diaphragm can be movable between a closed position to prevent fluid flow between the inlet chamber and the drain chamber and an open position to allow fluid flow between the inlet chamber and the drain chamber. The actuator can selectively allow fluid flow out of the pilot channel through a port coupled with the pilot channel to movement of the diaphragm.

At least one aspect relates to a valve assembly. The valve assembly can include a first portion, a second portion, and a diaphragm. The first portion can have an inlet chamber, a diaphragm chamber, and a drain chamber to form a first fluid path from the inlet chamber to the drain chamber. The second portion can include at least one channel forming a second fluid path and an actuator in the at least one channel.

The diaphragm can be between the first portion and the second portion. The actuator can be movable to control the position of the diaphragm to selectively allow fluid flow through the first fluid path.

### BRIEF DESCRIPTION OF THE DRAWINGS

FIG. 1 is a block diagram of an example of a fire protection system.

FIG. 2 is cross-sectional view of an example of a pilot valve of a fire protection system.

FIG. 3 is a cross-sectional view of an example of a pilot valve of a fire protection system.

### DETAILED DESCRIPTION

Following below are more detailed descriptions of various concepts related to, and implementations of pilot valves for fire protection systems (e.g., sprinkler systems), including dual interlock pilot valves. The various concepts introduced above and discussed in greater detail below can be implemented in any of numerous ways, including in dry systems and in wet systems, such as to selectively control activation of flow control valves responsive to detection of a fire condition (e.g., responsive to pressure changes resulting from sprinklers opening to allow air or fluids in the system to be outputted; responsive to electronic actuation of one or more actuators or valves based on detecting the fire condition using temperature, heat, gas, smoke, or other sensors).

Fire protection systems can include flow control valves, including diaphragm valves, that selectively allow fluid to flow to fluid distribution devices (e.g., sprinklers; nozzles) to address a fire condition. The sprinkler system may be a dry system, in which at least some piping to the sprinklers has air instead of water or other fluids. For example, dry systems may be useful in applications including but not limited to where the piping may be exposed to freezing or below-freezing temperatures.

In dry systems, the air in the piping may be pressurized to above atmospheric pressure. Responsive to a fire condition, the sprinklers can be triggered to an open state, allowing the pressurized air in the piping to be released from the sprinklers, and for components upstream of the sprinklers to change to a state to allow fluid flow out of the sprinklers. For example, flow control valves can be used to selectively allow fluid flow from a fluid supply to the sprinklers. However, due to the pressurization of the air in the piping (on the downstream side of the flow control valve), it can be difficult or ineffective to install and operate some flow control valves in dry systems. For example, diaphragm valves may be structured so that a diaphragm that seals an outlet from an inlet of the diaphragm valve might inadvertently open due to the air pressure on the outlet side of the diaphragm valve.

For example, a fire protection system can include a flow control valve, one or more sprinklers, and a pilot valve. The flow control valve can include an inlet, an outlet, a first diaphragm chamber between the inlet and the outlet, and a first diaphragm movable between a closed state to prevent fluid flow between the inlet and the outlet and an open state to allow fluid flow between the inlet and the outlet. The one or more sprinklers can be coupled with the outlet. The pilot valve can include an inlet chamber coupled with a diaphragm port of the first diaphragm chamber, a drain port, a second diaphragm in a second diaphragm chamber between the inlet chamber and the drain port, and an actuator in a pilot channel between the inlet chamber and an air port and between the inlet chamber and the drain port, the actuator to prevent fluid flow between the inlet chamber and the drain port through the pilot channel responsive to pressurization of one or more pipes between the outlet and the one or more sprinklers, the air port coupled with the one or more pipes, the actuator to allow fluid flow between the inlet chamber and the drain port and between the second diaphragm chamber and the drain port responsive to pressure in the one or more pipes being less than a threshold to allow operation of the flow control valve. As such, the pilot valve can enable the flow control valve to be used in dry pipe systems (or other systems in which an inlet side of the flow control valve may be pressurized during installation, setup, etc.), or can be used in various systems including deluge systems.

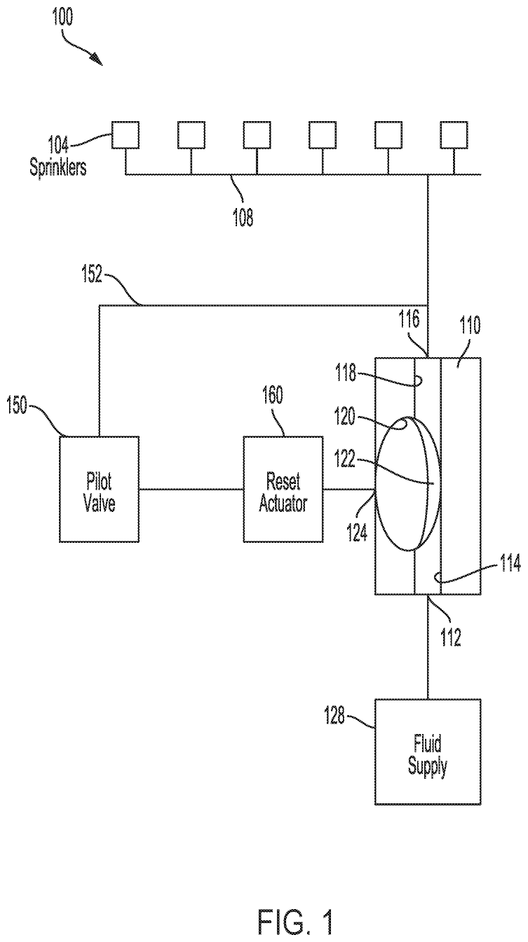

FIG. 1 depicts an example of a fire protection system 100. The fire protection system 100 can be a fire suppression system. The fire protection system 100 can be a chemical fire suppression system. The fire protection system 100 can distribute a fire suppressant agent onto or nearby a fire, extinguishing the fire and preventing the fire from spreading. The fire protection system 100 can be used alone or in combination with other types of fire suppression systems (e.g., a building sprinkler system, a handheld fire extinguisher). Multiple fire protection systems 100 can be used in combination with one another to cover a larger area (e.g., each in different rooms of a building).

The fire protection system 100 can be used in a variety of applications. The fire protection system 100 can be used with a variety of fire suppressant agents, including but not limited to water (e.g., may use powders, liquids, foams, or other fluid or flowable materials). The fire protection system 100 can be used for storage applications, including ceiling-only, in-rack, or a combination of ceiling and rack sprinklers, such as to be installed for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof.

The fire protection system 100 can include or be coupled with one or more fluid distribution devices, depicted in FIG. 1 as sprinklers 104. The fire protection system 100 can include nozzles for outputting fluid (e.g., nozzles used for deluge systems, including, for example, nozzles having open flow paths). The sprinklers 104 can include a deflector that outputs fluid according to a target spray pattern corresponding to the structure of the deflector. The sprinklers 104 can include an activation element, such as a glass bulb or link and lever assembly, which can change from a first state that maintains the sprinkler 104 in a closed state (e.g., holds a seal against an outlet of the sprinkler 104) to a second state to allow the sprinkler 104 to open to flow fluid against the deflector and towards a space around the sprinkler 104. The spray pattern of fluid from the sprinklers 104 can be outputted from the sprinklers 104 to suppress or extinguish fire within that area.

The sprinklers 104 can be used as concealed sprinklers, pendent sprinklers, upright sprinklers, water mist nozzles, or any other device for spraying fire suppressant agent. The sprinklers 104 can be early suppression, fast response (ESFR) sprinklers. The sprinklers 104 can have K-factors greater than or equal to 14.0 GPM/PSI 2 and less than or equal to 36.0 GPM/PSI 2 . The sprinklers 104 can be arranged (e.g., in a grid or tree arrangement over a storage commodity) to have sprinkler to sprinkler spacings greater than or equal to eight feet by eight feet and less than or equal to twelve feet by twelve feet.

The fire protection system 100 can include piping 108 connected with the sprinklers 104. The sprinklers 104 can receive water or other fire suppressant agent via the piping 108. The piping 108 can include various pipes to arrange in the sprinklers 104 in various configurations, including but not limited to tree or grid configurations. The piping 108 can include sprinkler risers.

The fire protection system 100 can include or be coupled with a fluid supply 128. The fluid supply 128 can define an internal volume filled (e.g., partially filled, completely filled) with fire suppressant agent. The fluid supply 128 can provide fluid from a remote or local location to a building in which the fire protection system 100 is located. The fluid supply 128 may include, for example, a municipal water supply, pump, piping system, tank, cylinder, or any other source of fluid or water or fire suppression agent.

The fire protection system 100 can include a valve 110, which can be a flow control valve. The valve 110 can be a diaphragm valve, such as the TYCO DV-5A AUTOMATIC WATER CONTROL VALVE manufactured by Tyco Fire Products of Cranston, Rhode Island. The valve 110 can be positioned between the fluid supply 128 and the sprinklers 104 to selectively permit fluid flow from the fluid supply 128 to the sprinklers 104.

The valve 110 can include an inlet 112 coupled with the fluid supply 128 and an outlet 116 coupled with the piping 108 (e.g., a sprinkler riser of the piping 108) and sprinklers 104. The valve 110 can include an inlet chamber 114 extending from the inlet 112, and an outlet chamber 118 extending from the outlet 116.

The valve 110 can include a diaphragm chamber 120 in which a diaphragm 122 is disposed. The diaphragm 122 can be made of a flexible material, such as at least one of a polymeric material, a rubber or synthetic rubber material (e.g., ethylene propylene diene monomer rubber), a nylon material, or a fabric material.

The diaphragm 122, as depicted in FIG. 1, can be in a closed state that prevents fluid flow from the inlet chamber 114 to the outlet chamber 118 (including to prevent fluid flow through the diaphragm chamber 120 from the inlet chamber 114). The diaphragm 122 can be caused to move from the closed state to an open state that allows for fluid flow between the inlet chamber 114 and the outlet chamber 118, such as to allow fluid flow from the fluid supply 128 to the piping 108 and the sprinklers 104. For example, the diaphragm 122 can be structured and arranged relative to the diaphragm chamber 120 (and other structures of the valve 110) such that, responsive to a decrease below a threshold of a ratio of a first pressure on a first side the diaphragm 122 in the diaphragm chamber 120 to a second pressure on a second side of the diaphragm 122 (e.g., corresponding to at least the surface of the diaphragm 122 facing the outlet chamber 118), the diaphragm 122 can move away from the closed state depicted in FIG. 1 towards a diaphragm port 124 to allow fluid to flow from the inlet chamber 114 into the outlet chamber 118.

For example, to operate the valve 110, any of various mechanical and/or electrical actuators and/or valves may be connected with the diaphragm port 124, and can be used to reduce the first pressure in the diaphragm chamber 120 (such as to allow fluid in the diaphragm chamber 120 to drain out of the diaphragm port 124). However, if the second pressure on the second side of the diaphragm 122 increases sufficiently such that the ratio of the first pressure to the second pressure decreases below the threshold, the diaphragm 122 may also move to the open state. This may occur, for example, due to pressurization of the air in the piping 108 for using the fire protection system 100 or components thereof for dry pipe applications. The valve 110 may also include drain lines and/or drain ports (not depicted) which may be connected with at least one of the outlet chamber 118 and the diaphragm chamber 120, and thus may allow for pressure on the diaphragm 122 to be released rather than used to properly seat the diaphragm 122 in the closed state.

The fire protection system 100 can include a pilot valve 150. The pilot valve 150 can facilitate installation and operation of the valve 110, including in applications, such as dry pipe applications, where the piping 108 on the downstream side of the outlet 116 may be pressurized to a pressure sufficient to cause the movement of the diaphragm 122. For example, the pilot valve 150 can be used to maintain the first pressure in the diaphragm chamber 120 sufficient to allow for the second pressure on the second side of the diaphragm 122 opposite the first side to be increased to a target pressure for system operation; the pilot valve 150 can subsequently be used to allow for proper actuation of the valve 110 responsive to a fire condition. As depicted in FIG. 1, the valve 110 can be connected by a pilot line 152 to a portion of the piping 108 downstream from the outlet 116 (e.g., connected with a sprinkler riser between the outlet 116 and the sprinklers 104).

Referring further to FIG. 1, the fire protection system 100 can include a reset actuator 160. The reset actuator 160 can be the TYCO MRA-1 MANUAL RESET ACTUATOR manufactured by Tyco Fire Products of Cranston, Rhode Island. The reset actuator 160 can have a first state to prevent fluid flow out of the diaphragm chamber 120 via the diaphragm port 124, and a second state to allow the fluid flow out of the diaphragm chamber 120, such as to cause the diaphragm 122 to move to the open state to allow fluid flow from the inlet chamber 114 to the outlet chamber 118.

Responsive to being in the second state, the reset actuator 160 can be maintained in the second state until operation of a plunger or other movable member (e.g., despite further changes in fluid pressures in the fire protection system 100 resulting from the sprinklers 104 opening). As depicted in FIG. 1, the reset actuator 160 is positioned between the pilot valve 150 and the diaphragm port 124, such that operation of the pilot valve 150 causes the reset actuator 160 to change to the second state, and subsequently the reset actuator 160 can maintain the valve 110 in the open state.

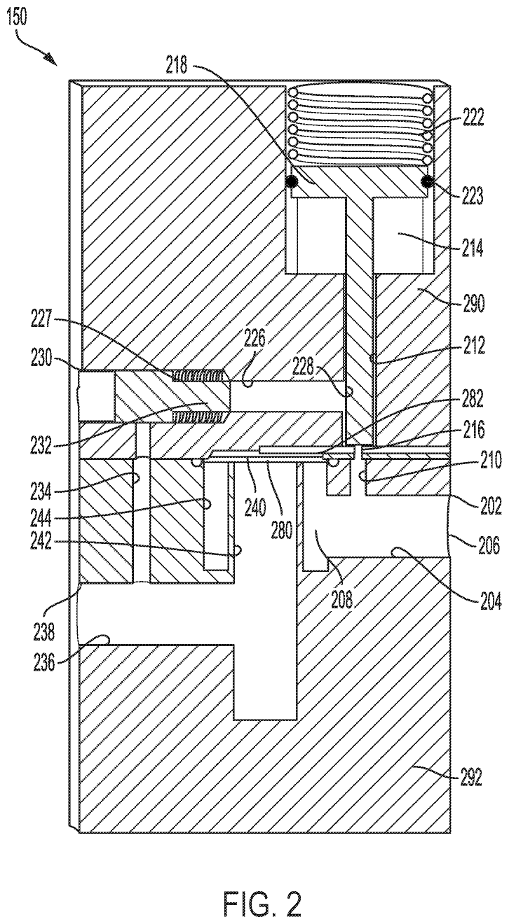

FIG. 2 depicts an example of the pilot valve 150. The pilot valve 150 can provide one or more interlock functions, which can allow the valve 110 to be implemented in non-interlock dry sprinkler systems. The pilot valve 150 can be made of one or more separate or integrally formed components. For example, the pilot valve 150 can be made of a head portion 290, a body portion 292, and a diaphragm 280. The diaphragm 280 can be made from similar material(s) as the diaphragm 122. By making the pilot valve 150 from the head portion 290, body portion 292, and diaphragm 280, the pilot valve 150 can be effectively assembled and/or have drillings made for various ports and channels.

The pilot valve 150 can have components to provide two interlocks, such as valve assemblies that facilitate interlock functions. For example, the pilot valve 150 can include a first, normally open interlock that connects with the piping 108 (e.g., to pilot line 152), and a second, normally closed interlock that connects with the valve 110 (e.g., with the inlet 112 and/or the piping between the fluid supply 128 and the inlet 112).

The pilot valve 150 can include an inlet port 202. The inlet port 202 can be connected with the valve 110, such as to be connected with a port of the valve 110 or the reset actuator 160 that allows the reset actuator 160 to open and drain fluid from the diaphragm chamber 120. An inlet chamber 204 can extend from the inlet port 202 from a first end 206 to a second end 208. Coupling the inlet port 202 with the valve 110 can facilitate fluid communication between the inlet chamber 204 and the diaphragm chamber 120, such as to allow for pressurization of the diaphragm chamber 120 (e.g., during system installation, setup, and/or maintenance) and depressurization of the diaphragm chamber 120 (e.g., responsive to a fire condition) to activate the valve 110 to the open state.

The pilot valve 150 can include a first pilot channel 210 extending away from the inlet chamber 204 from a point between the first end 206 and the second end 208, such as to extend transverse to a longitudinal axis of the inlet chamber 204. The first pilot channel 210 can have a smaller diameter than the inlet chamber 204.

The pilot valve 150 can include a second pilot channel 212 extending from the first pilot channel 210 to a valve chamber 214. The second pilot channel 212 can have a smaller diameter than the inlet chamber 204 and a greater diameter than the first pilot channel 210 to form an orifice 216 (e.g., choke orifice) between the first pilot channel 210 and the second pilot channel 212. The valve chamber 214 can be used to set the pilot valve 150 into an operational state, such as to pressurize components of the pilot valve 150 for implementation in a dry pipe system.

The second pilot channel 212 can extend from the orifice 216 to the valve chamber 214. As depicted in FIG. 2, the valve chamber 214 can have a plunger 218.

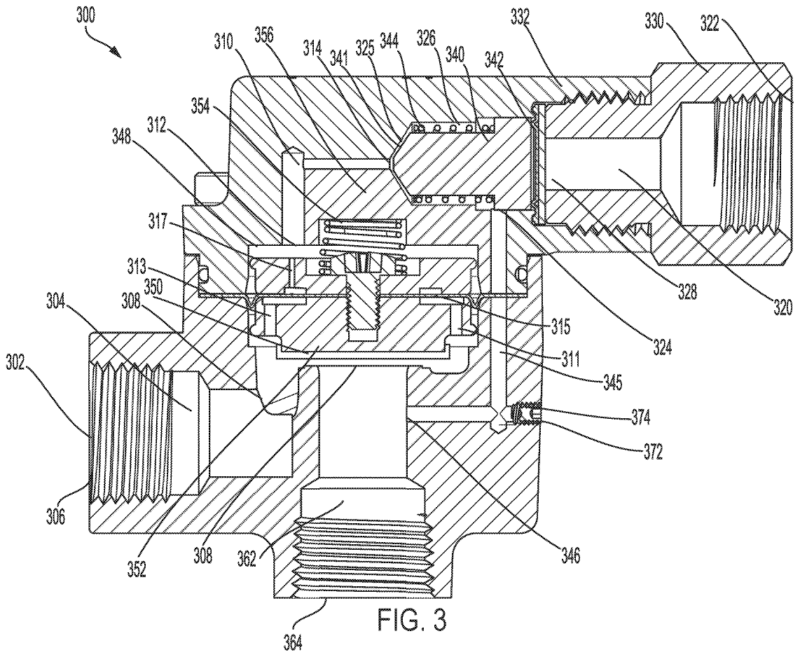

The plunger 218 can be a piston. The plunger 218 can include or be coupled with an O-ring 223 to form a seal around the plunger 218. The valve chamber 214 can have a spring 222 disposed in the valve chamber 214 on an opposite side of the plunger 218 from the second pilot channel 212. The spring 222 can be coupled with the plunger 218, such as to face the plunger 218 and/or be in contact with the plunger 218. The spring 222 and/or plunger 218 can be compressed by pressure in the valve chamber 214, which can allow for pressure to build up against the diaphragm 280. The pressure in the valve chamber 214 can be greater than atmosphere, while being less than system pressure in the piping 108 described with reference to FIG. 1. The pressure in the valve chamber 214 can correspond to water pressure in the valve 110. As described further with reference to FIG. 3, various pilot valves described herein may not include a valve chamber 214, plunger 218, and/or spring 222.

The pilot valve 150 can include a third pilot channel 226 extending from a port 228 of the second pilot channel 212 (e.g., in a direction transverse to a longitudinal axis of the second pilot channel 212 and/or parallel with the longitudinal axis of the inlet chamber 204). The third pilot channel 226 can extend from the port 228 to a port 230. The port 230 can be coupled with the piping 108 between the sprinklers 104 and the outlet 116 of the valve 110, which can allow pressure in the piping 108 to be applied to components in the third pilot channel 226. For example, the port 230 can be coupled with the pilot line 152 to be coupled with the piping 108.

As depicted in FIG. 2, the pilot valve 150 can include an actuator 232 in the third pilot channel 226. The actuator 232 can include a spring, valve member, stop, or other component that can move responsive to air pressure in the third pilot channel 226. For example, responsive to air pressure from the pilot line 152 exceeding a threshold, the actuator 232 can be positioned in a closed state (as depicted in FIG. 2) to close the connection between the second pilot channel 212 and the third pilot channel 226, allowing for pressure to increase in the inlet chamber 204, which can apply backpressure on the diaphragm 122 in the diaphragm chamber 120. The actuator 232 can be coupled with a spring 227, which can be positioned around at least a portion of the actuator 232 and/or to face one or more surfaces of the actuator 232. The spring 227 can facilitate control of movement of the actuator 232 relative to the closed state.

Responsive to the air pressure in the pilot line 152 falling below the threshold, the actuator 232 can move from the closed state depicted in FIG. 2 away from the port 228 towards the port 230 to allow fluid communication between the second pilot channel 212 and a fourth pilot channel 234 coupled with the third pilot channel 226.

In various implementations, the port 230 and/or the pilot line 152 can be additionally or alternatively coupled with various manual or electronic actuators, accelerators, or other components that can cause pressure in the third pilot channel 226 to decrease to allow the actuator 232 to move towards the port 230 and fluidly couple the second pilot channel 212 with the fourth pilot channel 234. For example, various such components can be used to more rapidly vent the pilot valve 150 to more rapidly actuate the valve 110.

As depicted in FIG. 2, the fourth pilot channel 234 is coupled with a drain chamber 236 and drain port 238, such that fluid in the fourth pilot channel 234 can flow out of the pilot valve 150 through the drain port 238. For example, responsive to the actuator 232 moving from the closed state towards the port 230 to allow fluid communication between the second pilot channel 212 and the fourth pilot channel 234, fluid in the second pilot channel 212 can flow out of the drain port 238.

As depicted in FIG. 2, the pilot valve 150 includes a diaphragm chamber 240 in which the diaphragm 280 is positioned. The diaphragm chamber 240 can include a central portion 242 and an outer portion 244 around the central portion 242. The central portion 242 can extend into and be fluidly coupled with the drain chamber 236. The outer portion 244 can extend from and be fluidly coupled with the second end 208 of the inlet chamber 204.

In the closed state of the diaphragm 280 depicted in FIG. 2, the diaphragm 280 can be positioned to prevent (e.g., block, seal) fluid from flowing from the outer portion 244 into the central portion 242. For example, pressure from water in the first pilot channel 210 and an orifice channel 282 can be applied against the diaphragm 280 to hold the diaphragm 280 against the central portion 242 and the outer portion 244 to prevent fluid flow between the outer portion 244 and the central portion 242.

The diaphragm chamber 240 and/or orifice channel 282 can be shaped to apply a default pressure differential across the diaphragm 280 to hold the diaphragm 280 against the central portion 242 and outer portion 244. For example, the surface area of the diaphragm 280 facing the orifice channel 282 can be greater than the surface area facing the central portion 242.

Responsive to the actuator 232 moving towards the port 230 to allow pressure in the second pilot channel 212 and the orifice channel 282 to decrease, the pressure holding the diaphragm 280 against the outer portion 244 can decrease, allowing the diaphragm to be moved away from the outer portion 244 (e.g., due to water pressure from fluid in the outer portion 244 from the fluid in the inlet chamber 204), fluidly coupling the outer portion 244 with the central portion 242. Responsive to the outer portion 244 being fluidly coupled with the central portion 242, fluid in the inlet chamber 204 can flow out from the outer portion 244 through the central portion 242 and out of the drain port 238, allowing for pressure in the diaphragm chamber 120 to decrease and the diaphragm 122 to move to the open state to allow fluid flow through the valve 110 to the sprinklers 104.

The inlet chamber 204, diaphragm chamber 240, and drain chamber 236 can form a first fluid path (e.g., through the body portion 292), which the diaphragm 280 can seal while under pressure from water in the orifice channel 282. The orifice channel 282, second pilot channel 212, third pilot channel 226, and fourth pilot channel 234 can form a second fluid path (e.g., through the head portion 290), which can connect with the first pilot channel 210 and the drain chamber 236.

Referring further to FIGS. 1 and 2, during installation, setup, maintenance, and/or reset of the fire protection system 100, among other operations, the inlet port 202 of the pilot valve 150 can be connected to the diaphragm port 124 of the valve 110 (e.g., directly or with one or more various actuators between the pilot valve 150 and the valve 110, such as the reset actuator 160). Fluid (e.g., water) can be flown into the diaphragm chamber 120, and can build up pressure in the inlet chamber 204 to a target pressure (e.g., of water) to hold the diaphragm 122 in the closed state, as well as to increase pressure in the valve chamber 214 against the spring 222 (e.g., compressing the spring 222), and to hold the diaphragm 280 closed against the outer portion 244 and central portion 242 of the diaphragm chamber 240. As air pressure in the piping 108 is increased to a target pressure (e.g., of air), this air pressure can be applied through the pilot line 152 and the port 230 to move the actuator 232 to the closed state to prevent fluid flow between the second pilot channel 212 and the drain port 238.

Responsive to a fire condition, various operations may occur that may result in air pressure in at least one of the piping 108, the pilot line 152, and the third pilot channel 226 decreasing. For example, one or more sprinklers 104 may be activated, allowing air in the piping 108 to flow out of the sprinklers 104; an actuator coupled with the port 230 can be activated to allow for air to flow out of the third pilot channel 226. Responsive to the pressure in the third pilot channel 226 decreasing below the corresponding threshold, the actuator 232 can open to allow fluid communication between the second pilot channel 212, the third pilot channel 226, the fourth pilot channel 234, and the drain port 238, allowing fluid to flow out of the second pilot channel 212 and decreasing the pressure applied against the diaphragm 280 via the orifice channel 282.

Responsive to the pressure applied against the diaphragm 280 (e.g., on a first side of the diaphragm 280 facing the orifice channel 282) decreasing below a corresponding threshold, the diaphragm 280 can move away from at least one of the central portion 242 and the outer portion 244 to allow fluid communication between the central portion 242 and the outer portion 244; as such, fluid in the diaphragm chamber 120, which is coupled with the inlet chamber 204, can flow out of the diaphragm chamber 120 through the inlet chamber 204, the diaphragm chamber 240, and the drain port 238, allowing pressure in the diaphragm chamber 120 to decrease, allowing the diaphragm 122 to move to the open state to allow fluid to flow from the inlet 112 out of the outlet 116 to the sprinklers 104.

FIG. 3 depicts an example of a pilot valve 300. The pilot valve 300 can include one or more components of the pilot valve 150 described with reference to FIGS. 1 and 2, such as to perform functions such as facilitating one or more interlocks with respect to a valve coupled with the pilot valve 300. The pilot valve 300 can be used to implement the pilot valve 150 as depicted in FIG. 1.

The pilot valve 300 can include an inlet port 302. The inlet port 302 can be connected with the valve 110, such as to be connected with a port of the valve 110 or the reset actuator 160 that allows the reset actuator 160 to open and drain fluid from the diaphragm chamber 120.

The pilot valve 300 can include an inlet chamber 304 that extends from the inlet port 302 from a first end 306 to a second end 308. Coupling the inlet port 302 with the valve 110 can facilitate fluid communication between the inlet chamber 304 and the diaphragm chamber 120, such as to allow for pressurization of the diaphragm chamber 120 (e.g., during system installation, setup, and/or maintenance) and depressurization of the diaphragm chamber 120 (e.g., responsive to a fire condition) to activate the valve 110 to the open state.

The pilot valve 300 can include a first pilot channel 310. The pilot channel 310 can extend between a port 312 coupled with the inlet chamber 304 and a port 314. The channel 310 can be fluidly coupled with the inlet chamber 304 to allow for fluid to flow from the inlet chamber 304. For example, the pilot valve 300 can include at least one of a channel 311 and a channel 313 to allow for fluid communication between the inlet chamber 304 and the pilot channel 310, such as through a passageway 315 and out of a restricting orifice 317.

The pilot valve 300 can include a second pilot channel 320. The second pilot channel 320 can be formed in a separate member of the pilot valve 300 from the inlet chamber 304. The second pilot channel 320 can extend between a port 322 and the port 314, and can form a channel portion 326 coupled with the port 324 and the port 314 and a channel portion 328 coupled with the port 322. The channel portion 328 can be formed in a member 330 that can be threadingly received by a portion 332 of the pilot valve 300 that forms the channel portion 326, which can allow for access to plunger 340, such as for resetting operation of the pilot valve 300.

As depicted in FIG. 3, the pilot valve 300 can include a plunger 340, which can be disposed in the second pilot channel 320, such as to be disposed in the channel portion 326. The plunger 340 can allow for selective coupling of the first pilot channel 310 (e.g., the first pilot channel 310 being in fluid communication with the inlet chamber 304) with the port 324 by way of the second pilot channel 320. As depicted in FIG. 3, the plunger 340 can be coupled with a seal 342 on a side of the plunger 340 facing the port 322. The plunger 340 can be coupled with a spring 344 disposed at least partially around and/or in contact with the plunger 340, such as to apply a force against the plunger 340 in a direction towards the port 322.

Referring to FIG. 1 and to FIG. 3, the port 322 can be coupled with the pilot line 152, such has to be coupled with the piping 108. Responsive to a decrease in pressure in the pilot line 152 (e.g., due to operation of an actuator, or pressure drop in the piping 108) pressure in the channel portion 328 on the plunger 340 can decrease, such as to decrease below a threshold, to allow the plunger 340 to move in a direction towards the port 322, such as due to operation of the spring 344 on the plunger 340.

As such, the plunger 340 can shift (e.g., to the position depicted in FIG. 3) to allow the port 314 to be coupled with the channel portion 326 and to the port 324, such as to form a fluid connection from the inlet chamber 304 into port 346.

As depicted in FIG. 3, the channel portion 326 can form a tapering portion 325 towards the port 314, such as to form the port 314 adjacent to angled walls of the channel portion 326. The tapering portion 325 can allow for the sealing of the port 314 to be focused to the shape of the port 314, such as to allow for relatively low air pressure to seal a relatively high amount of water pressure. The plunger 340 can have a taper 341. The taper 341 can have a first angle different than a second angle of the tapering portion 325 (e.g., at least one degree greater), which can allow for a controlled and designed force concentration creating the seal for port 314. The plunger 340 can be made of an elastomeric material, such as to be resilient and/or rigid, while able to seal without lubricant. An example of such an elastomeric material is urethane, which can allow the plunger 340 to effectively operate together with the tapering portion 325 while maintaining structural integrity.

As depicted in FIG. 3, the pilot valve 300 can include a third pilot channel 345 extending between the port 324 and a port 346 coupled with a seal chamber 348. The seal chamber 348 can include a seal 350, such as a diaphragm (e.g., rubber member). The seal 350 can be moved between a first position in which the seal 350 covers the second end 308 of the inlet chamber 304 to prevent fluid flow from the inlet chamber 304 into drain chamber 362, and a second position (e.g., as depicted in FIG. 3) in which the inlet chamber 304 is open to the drain chamber 362. The pilot valve 300 can include a port 372 between the third pilot channel 345 and the drain chamber 362, which can receive a screw 374 (e.g., set screw) to plug the port 372.

As depicted in FIG. 3, the pilot valve 300 can include an actuator 352 facing the seal 350. The actuator 352 can be used to bias the seal 350 to the first position to seal the inlet chamber 304 from the seal chamber 348, such as by operation of spring 354 against the actuator 352 (e.g., by way of member 356 applying force from the spring 354 against the actuator 352). The seal 350 can have a resilience sufficient to bias the seal 350 to the first position (e.g., with or without the inclusion of the actuator 352).

Responsive to the plunger 340 moving to the open position, pressure on the seal 350 can decrease to allow the seal 350 to move away from the inlet chamber 304 to fluidly couple the inlet chamber 304 with a drain chamber 362. This can allow for actuation of the valve 110 that is coupled with the inlet chamber 304 by allowing for pressure decrease and/or fluid flow out of the valve 110 (e.g., out of diaphragm chamber 120 coupled with the inlet chamber 304). The drain chamber 362 can be coupled with the seal chamber 348 and a port 364 to connect with atmosphere and/or drain piping. As an example, responsive to a pressure condition in the second pilot channel 320 corresponding to a fire condition, the plunger 340 can be moved to the position depicted in FIG. 3 to allow pressure on the actuator 352 and/or seal 350 to decrease, allowing the seal 350 to move to the position depicted in FIG. 3 to couple the inlet chamber 304 with the drain chamber 362 to allow for fluid from the valve 110 to be directed out of the valve 110 through the drain chamber 362.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A fire protection system, comprising:
a flow control valve comprising an inlet, an outlet, a first diaphragm chamber between the inlet and the outlet, and a first diaphragm movable between a closed state to prevent fluid flow between the inlet and the outlet and an open state to allow fluid flow between the inlet and the outlet;
one or more fluid distribution devices coupled with the outlet; and
a pilot valve, comprising:
an inlet chamber coupled with a diaphragm port of the first diaphragm chamber;
a drain port;
a second diaphragm in a second diaphragm chamber between the inlet chamber and the drain port; and
an actuator in a pilot channel between the inlet chamber and an air port and between the inlet chamber and the drain port, the actuator to prevent fluid flow between the inlet chamber and the drain port through the pilot channel responsive to pressurization of one or more pipes between the outlet and the one or more fluid distribution devices, the air port coupled with the one or more pipes, the actuator to allow fluid flow between the inlet chamber and the drain port and between the second diaphragm chamber and the drain port responsive to pressure in the one or more pipes being less than a threshold to allow operation of the flow control valve.

2. The fire protection system of claim 1, comprising:
the pilot valve comprises an orifice between the inlet chamber and the actuator.

3. The fire protection system of claim 1, comprising:
a spring in a valve chamber coupled with the inlet chamber to be compressed by pressure in the valve chamber.

4. The fire protection system of claim 1, comprising:
the actuator is positioned to reduce pressure on a first side of the second diaphragm responsive to the pressure in the one or more pipes being less than the threshold to allow fluid flow from the inlet chamber through the second diaphragm chamber out of the drain port.

5. The fire protection system of claim 1, comprising:
the pilot valve is structured to prevent air pressure in the outlet of the flow control valve from moving the first diaphragm to the open state.

6. The fire protection system of claim 1, comprising:
a reset actuator connecting the diaphragm port of the flow control valve with the inlet chamber of the pilot valve, the reset actuator to prevent the first diaphragm from moving to the closed state responsive to the first diaphragm being in the open state.

7. The fire protection system of claim 1, comprising:
the pilot channel is a third pilot channel, and the pilot valve comprises a first pilot channel extending from the inlet chamber to an orifice, a second pilot channel extending from the orifice to a valve chamber, a spring in the valve chamber, and the third pilot channel extending from the second pilot channel, the first pilot channel having a smaller diameter than the inlet chamber and the second pilot channel.

8. The fire protection system of claim 1, comprising:
the fire protection system is a dry pipe system.

9. The fire protection system of claim 1, comprising:
the one or more pipes between the outlet and the one or more fluid distribution devices, the one or more pipes having air at a pressure greater than atmosphere.

10. The fire protection system of claim 1, comprising:
the pilot valve comprises a head portion in which the actuator is disposed and a body portion in which the inlet chamber and the drain port are disposed, the second diaphragm between the head portion and the body portion.

11. The fire protection system of claim 1, comprising:
the one or more fluid distribution devices comprise at least one of a pendent sprinkler, an upright sprinkler, and a nozzle.

12. A pilot valve, comprising:
an inlet chamber;
a diaphragm chamber coupled with the inlet chamber;
a drain chamber coupled with the diaphragm chamber;
a diaphragm movable between a closed position to prevent fluid flow between the inlet chamber and the drain chamber and an open position to allow fluid flow between the inlet chamber and the drain chamber;
a pilot channel coupled with the inlet chamber; and
an actuator in the pilot channel, the actuator to selectively allow fluid flow out of the pilot channel through a port coupled with the pilot channel responsive to movement of the diaphragm.

13. The pilot valve of claim 12, comprising:
an orifice between the inlet chamber and the pilot channel.

14. The pilot valve of claim 12, comprising:
a spring in a valve chamber coupled with the inlet chamber to be compressed by pressure in the inlet chamber.

15. The pilot valve of claim 12, comprising:
the actuator is sized to move, responsive to pressure in the pilot channel decreasing below a threshold, to reduce pressure on the diaphragm to move the diaphragm.

16. The pilot valve of claim 12, comprising:
the pilot channel is a third pilot channel, and the pilot valve comprises a first pilot channel extending from the inlet chamber to an orifice, a second pilot channel extending from the orifice to a valve chamber, a spring in the valve chamber, and the third pilot channel extending from the second pilot channel, the first pilot channel having a smaller diameter than the inlet chamber and the second pilot channel.

17. The pilot valve of claim 12, comprising:
a head portion in which the actuator is disposed and a body portion in which the inlet chamber and the drain chamber are disposed, the diaphragm between the head portion and the body portion.

18. A valve assembly, comprising:
a first portion having an inlet chamber, a diaphragm chamber, and a drain chamber to form a first fluid path from the inlet chamber to the drain chamber;
a second portion having at least one channel forming a second fluid path and an actuator in the at least one channel; and
a diaphragm between the first portion and the second portion, the actuator movable to control the position of the diaphragm to selectively allow fluid flow through the first fluid path.

19. The valve assembly of claim 18, comprising:
the actuator comprises an elastomer material; and
the at least one channel comprises a tapering portion.

20. The valve assembly of claim 18, comprising:
the actuator has a tapered end tapered at a first angle; and
the at least one channel comprises a tapered port to receive the actuator to form a seal between the actuator and the tapered port, the tapered port tapered at a second angle, the first angle greater than the second angle.
